(19) United States
(12) Patent Application Publication
(10) Pub. No.: US 2004/0150168 A1
(43) Pub. Date: Aug. 5, 2004

(54) Power end seal

(76) Inventors: Joe William Heathcott, Missouri City, TX (US); Martha L. Heathcott, Missouri City, TX (US); Chris MacKelvey, Houston, TX (US)

Correspondence Address: DAVID M. O'BRIAN, 5007 HARTWELL DR., HOUSTON, TX, 77084, US

(21) Appl. No.: 10/761,041

(22) Filed: Jan. 20, 2004

Related U.S. Application Data
(60) Provisional application No. 60/440,923, filed on Jan. 18, 2003.

(51) Int. Cl. F16J 15/16

(52) U.S. Cl. 277/500

(57) ABSTRACT

A one-piece, circular, power end seal for use in sealing gear boxes of heavy-duty reciprocating pumps. The power end seal generally includes a u-shaped, circular seal body having an open channel, a plurality of ribs tangentially mounted within the channel and a ring-shaped, fiber-filled dynamic seal being formed within an inner diameter wear surface of the seal body. The ribs generally provide the seal body with improved flexibility to maintain a constant and effective seal around connecting rods within the gear box, while at the same time retaining sufficient resilience to maintain static interference in a packing gland within the gear box. The inner diameter dynamic seal can be filled with PTFE, bronze filled PTFE, carbon filled PTFE or aramid fiber filled HNBR, which reduces heat build up and seal wear, while minimizing the radial squeeze of the seal in contact with the circumference of the connecting rod.

Priority for this non-provisional patent application is claimed under 35 U.S.C. § 119, pursuant to Applicant's provisional patent application, application No. 60/440,923 filed on Jan. 18, 2003.

### FIELD OF THE INVENTION

A one-piece, circular, power end seal for use in sealing gear boxes of heavy-duty reciprocating pumps.

### BACKGROUND OF THE INVENTION

In the past, conventional seals have been used for gear boxes in reciprocating pumps, and the like. These seals generally located in a packing bore and are used to seal the circumferential area of a connecting rod of the pump, as the rod passes back and forth through the seal. These seals are designed to generally prevent gas and/or fluid leakage between the connecting rod and the packing bore. The problems of these conventional type seals include general leakage of gas and/or fluids, premature failure including failure due to excessive heat and deflection, inability to withstand high duty cycles, and connecting rod and shaft misalignment in low system pressure applications. Seal failure and replacement is aggravating, expensive, lowers productivity and is time consuming. The present invention power end seal overcomes the deficiencies of the known seals used in power end applications.

### SUMMARY OF THE INVENTION

To achieve the foregoing objects, features and advantages in accordance with the purpose of the invention as embodied and broadly described herein, a power end seal for use in sealing gear boxes of heavy-duty reciprocating pumps is presented which overcomes the deficiencies of the known seals used in power end applications, is presented. The present invention provides a preferred embodiment power end seal generally consisting of a u-shaped, circular seal body having an open channel portion, a plurality of ribs being affixed within the channel portion and a ring-shaped, fiber-filled dynamic seal being formed within an inner diameter wear surface of the seal body. The seal body further includes an inner wall portion, an outer wall portion and a seat portion, wherein the seat portion is affixed to a lower end of the inner wall portion and a lower end of the outer wall portion to form the u-shaped channel. The ribs are generally tangentially-mounted within the open channel portion such that the ribs are attached to the lower end of an outer diameter surface of the inner wall portion, an inner diameter surface of the outer wall portion and a top surface of the seat portion. The tangential mounting of the ribs within the open channel portion, generally allows for the selective expansion and selective contraction of an upper end of the inner wall portion and the outer wall portion of the seal body, while maintaining the seal capabilities to retain the lubricants used with the gear boxes, in relation to the forces being applied to the seal body. The ribs generally provide the present seal body with the desirable feature of improved flexibility to maintain a constant seal around the connecting rod, even when the connecting rod becomes misaligned with the seal, while at the same time the present seal body retains enough resilience to maintain static interference in the packing bore. The inner diameter wear surface is formed on the inner diameter of the inner wall portion. The dynamic seal can be filled with PTFE, bronze filled PTFE, Carbon filled PTFE or can alternatively be filled with aramid fiber filled HNBR (rubber), all of which have the effect of reducing heat build up and seal wear, while minimizing the radial squeeze of the seal in contact with the circumference of the connecting rod. The seal body further includes an outer diameter rubber static seal on an outer diameter surface of the outer wall portion and the bottom surface of the seat portion, wherein the outer wall portion and the seat portion contact and engage the seal surface of the packing bore of the gear box.

### DRAWINGS

FIG. 1 is a perspective, cut-away view of the preferred embodiment power end seal illustrating the U-shaped, circular structure of the seal body and the inner diameter dynamic seal wall consisting of the composite dynamic seal and the outer diameter rubber static seal.

FIG. 2 is a cross-sectional view of the preferred embodiment power end seal.

FIG. 3 is plan view of the preferred embodiment power end seal illustrating the tangentially positioned ribs positioned between the inner and outer walls of U-shaped body.

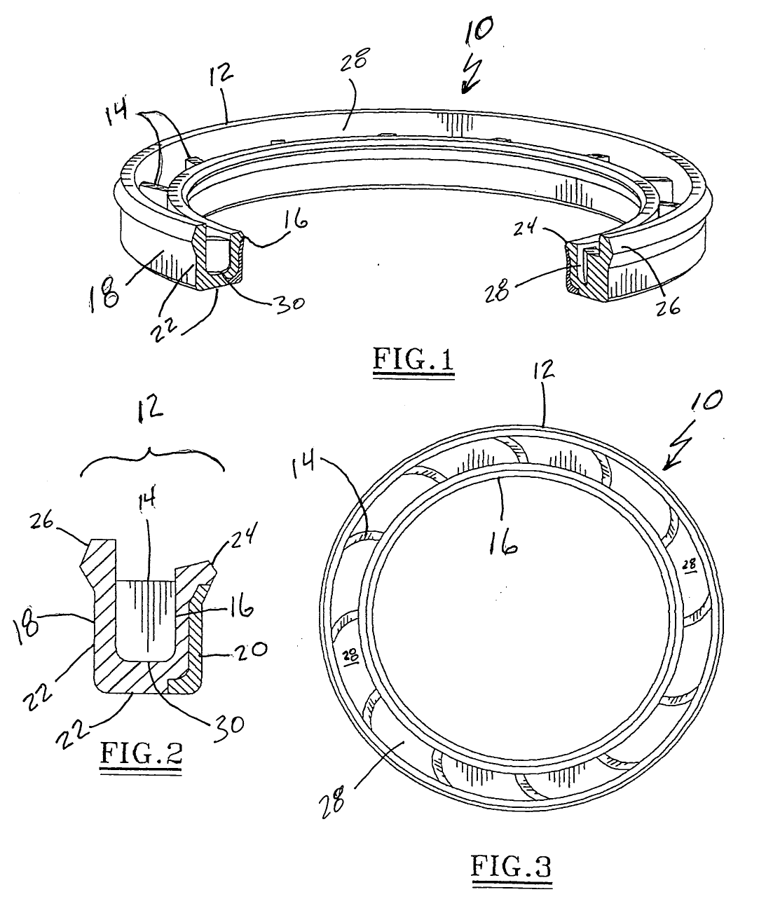

### DETAILED DESCRIPTION OF THE INVENTION

The present invention power end seal 10 is designed for, among other purposes, use in gear boxes (not shown) for reciprocating pumps to retain the lubricants used within the gear boxes. Conventional seals used in gear boxes can exhibit special sealing concerns due to high duty cycles, extension rods on pump power ends, and other rod and shaft misalignment in low system pressure applications. The present invention power end seal 10 is a composite seal that optimizes the properties of elastomers and plastic or elastomer composite materials. The present invention power end seal 10 is generally comprised of a U-shaped, circular seal body 12 having a plurality of arced or tangentially-positioned ribs 14 disposed between an inner diameter wall 16 and the outer diameter wall 18. Further, the present invention power end seal 10 includes an inner diameter dynamic seal 20 consisting of a plastic or elastomer filled composite material and the outer diameter rubber static seal 22. One of the primary benefits of the present invention power end seal 10 is its flexibility to compensate for run-out, or eccentricity. In other words, the power end seal 10 can withstand a large amount of deflection and still maintain static interference in the packing bore (not shown). Another benefit of the present invention power end seal 10 is that it can withstand the above-described deflection while minimizing radial squeeze to reduce heat build up and reduce seal wear. The inner dynamic seal 20 being comprised of plastic or elastomer filled composite material, i.e., for example PTFE, bronze filled PTFE, carbon filled PTFE or aramid fiber filled HNBR (rubber), significantly reduces the wear of the dynamic seal 20 of the seal body 12 while maintaining an effective and flexible dynamic seal 20 and static seal 22. The plurality of tangentially positioned ribs 14 provide flexible tension between the inner wall 16 and outer wall 18 of the power end seal 10 to maintain static interference in the packing gland (not shown), which is especially useful where there is no system pressure in the power ends of the gear boxes (not shown). A channel portion 28 is defined by the space between the inner diameter wall 16 and the outer diameter wall 18. The plurality of ribs 14 are tangentially positioned between the inner diameter wall 16 and the outer diameter wall 18 and are attached to a top surface 30 of the channel portion 28. The present invention power end seal 10 can be used in operating temperatures ranging from −20 to 300 degrees F. Various parts of the power end seal 10 are produced from the processes of compression, injection or transfer molded elastomer. Adhesion of the inner diameter wall 16 and outer diameter wall 18 is achieved by adhesive bonding in the molding process for dissimilar materials. Similar materials such as elastomer to fiber filled elastomer is generally achieved by the process of co-vulcanization. The use of higher modulus materials for the inner diameter dynamic seal surface 20, generally provides that the inner dynamic seal surface 20 does not pull away from the connecting rod (not shown) during operation of the pump (not shown). Rather, diametrical tension causes the inner diameter dynamic seal 20 to travel with the connecting rod (not shown) thus reducing leakage within the gear box (not shown). The use of plastic of elastomer filled composite material on the inner diameter dynamic seal 20 reduces the footprint or exposure of the higher friction elastomer used to form the seal body 12. Additionally, the present invention power end seal 10 discloses various lip profiles 24, 26 at the upper ends of the inner wall 16 and outer wall 18. Different lip profiles can be formed to the inner wall 16 and outer wall 18 depending upon the specific application for the power end seal 10.

What is claimed is:

1. A power end seal for use in sealing gear boxes of heavy duty reciprocating pumps, comprising:
a unshaped, circular seal body having an inner wall portion, an outer wall portion and a seat portion, wherein the seat portion is affixed to a lower end of the inner wall portion and a lower end of the outer wall portion;
an open channel portion being defined by an outer diameter surface of the inner wall portion, an inner diameter surface of the outer wall portion and a top surface of the seat portion;
a plurality of ribs, each of said ribs being mounted within said open channel portion, wherein each of said plurality of ribs is tangentially attached to the lower end of the outer diameter surface of the inner wall portion and the lower end of the inner diameter surface of the outer wall portion, and wherein a bottom surface of each of said ribs is diagonally attached to the top surface of the seat portion, such that an upper end of the inner wall portion and an upper end of the outer wall portion can selectively expand and selectively contract in relation to the forces being applied to said seal body;
an inner diameter composite dynamic seal, wherein said dynamic seal is structurally formed within an inner diameter wear surface of said inner wall portion; and
an outer diameter rubber static seal, wherein said static seal includes an outer diameter surface of the outer wall portion and a bottom surface of the seat portion.
